(19) United States
(12) Patent Application Publication
(10) Pub. No.: US 2026/0285300 A1
(43) Pub. Date: Sep. 24, 2026

(54) SYSTEMS AND METHODS OF IMMINENT COLLISION DETECTION AND MITIGATION FOR AUTONOMOUS VEHICLES

(71) Applicant: Torc Robotics, Inc., Blacksburg, VA (US)

(72) Inventors: Christos Kostoglou, Stuttgart (DE); Amitai Perlstein, Esslingen am Neckar (DE); Dimitrios Tzempetzis, Stuttgart (DE); Florian Wittl, Oberstenfeld (DE)

(21) Appl. No.: 19/085,152

(22) Filed: Mar. 20, 2025

(51) Int. Cl. B60W 30/09; B60R 21/0134; B60R 21/34; B60R 21/36; B60W 10/20; B60W 30/095; B60W 30/14; B60W 60/00; G06V 10/70; G06V 20/56

(52) U.S. Cl. CPC B60W 30/09; B60R 21/0134; B60R 21/36; B60W 10/20; B60W 30/0956; B60W 30/143; B60W 60/0015; G06V 10/70; G06V 20/588; B60R 2021/346; B60W 2420/403; B60W 2554/402

(57) ABSTRACT

A collision mitigation assembly of an autonomous vehicle for mitigating an imminent collision involving the autonomous vehicle is provided. The collision mitigation assembly includes a collision mitigation controller. The collision mitigation controller includes at least one processor. The at least one processor is programmed to receive sensor data. The at least one processor is also programmed to identify one or more objects in the environment based on the sensor data. The at least one processor is further programmed to determine that a collision is imminent based on the one or more objects. Moreover, the at least one processor is programmed to bypass at least part of a perception, planning, and control system of the autonomous vehicle. Additionally, the at least one processor is programmed to initiate one or more mitigating actions based on a determination that the collision is imminent.

### TECHNICAL FIELD

The field of the disclosure relates generally to autonomous vehicles and, more specifically, autonomous vehicle collision detection and mitigation.

### BACKGROUND OF THE INVENTION

An autonomous vehicle (AV) relies on its autonomy computing system to perceive the environment in which the AV is travelling, plan based on the perceptions, and control operation based on the planning. The detection and mitigation of collisions in AV's may present challenges. For example, an AV should reliably detect potential collisions, and should respond appropriately and timely to a wide variety of dynamic and unpredictable driving situations. Accordingly, it is desirable to improve the effectiveness and reliability of collision detection and mitigation assemblies in AVs to enhance safety and performance.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a collision mitigation assembly of an autonomous vehicle for mitigating an imminent collision involving the autonomous vehicle is provided. The collision mitigation assembly includes a collision mitigation controller. The collision mitigation controller includes at least one processor in communication with at least one memory device. The at least one processor is programmed to receive sensor data of an environment from one or more sensors of an autonomous vehicle while the autonomous vehicle is traveling in the environment. The at least one processor is also programmed to identify one or more objects in the environment based on the sensor data. The at least one processor is further programmed to determine that a collision with at least one of the one or more objects is imminent based on the one or more objects. Moreover, the at least one processor is programmed to bypass at least part of a perception, planning, and control system of the autonomous vehicle. Additionally, the at least one processor is programmed to initiate one or more mitigating actions based on a determination that the collision is imminent.

In another aspect, a method for mitigating an imminent collision involving an autonomous vehicle is provided. The method includes receiving sensor data of an environment from one or more sensors of an autonomous vehicle while the autonomous vehicle is traveling in the environment. The method also includes identifying one or more objects in the environment based on the sensor data. The method further includes determining that a collision with at least one of the one or more objects is imminent based on the one or more objects. Moreover, the method includes bypassing at least part of a perception, planning, and control system of the autonomous vehicle. Additionally, the method includes initiating one or more mitigating actions based on a determination that the collision is imminent.

In yet another aspect, a non-transitory computer-readable medium storing instructions that, when executed by a processor of an autonomous vehicle, cause the processor to perform a method for mitigating an imminent collision involving the autonomous vehicle is provided. The method includes receiving sensor data of an environment from one or more sensors of an autonomous vehicle while the autonomous vehicle is traveling in the environment. The method also includes identifying one or more objects in the environment based on the sensor data. The method further includes determining that a collision with at least one of the one or more objects is imminent based on the one or more objects. Moreover, the method includes bypassing at least part of a perception, planning, and control system of the autonomous vehicle. Additionally, the method includes initiating one or more mitigating actions based on a determination that the collision is imminent.

Various refinements exist of the features noted in relation to the above-mentioned aspects. Further features may also be incorporated in the above-mentioned aspects as well.

These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a block diagram of an example autonomous vehicle includes a collision mitigation assembly;

FIG. 3B is a block diagram of an example collision mitigation assembly;

FIG. 3C is a schematic diagram of an example cushioning structure;

FIG. 4 is a flow chart of an example collision mitigation method;

FIG. 5 is a block diagram of an example computing device;

FIG. 6A is a is a block diagram of an example neural network model; and

FIG. 6B is a is a block diagram of a neuron in the neural network model shown in FIG. 6A.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems, assemblies, and methods for collision mitigation in autonomous vehicles are provided. The systems and methods described herein offer significant advantages in reducing the severity of impacts during imminent collisions. By integrating sensors, including cameras, the system provides real-time, high-accuracy detection of imminent collisions, enabling proactive responses that enhances safety for both vehicle occupants and other road users.

The collision mitigation assembly described herein includes a collision mitigation controller configured to detect an imminent collision and initiate mitigating actions. The disclosed system is configured to detect objects in the vehicle's environment with precision, even in complex scenarios. The perception and understanding module processes sensor data to identify and track objects such as pedestrians, other vehicles, and obstacles. The objects are then analyzed by the collision mitigation controller to determine whether a collision is imminent. In some embodiments, the detection of objects is based on a relatively few number of frames of camera data, thereby increasing the speed of detection and providing decision making with increased speed.

At least some known systems often rely on a combination of sensors such as cameras, radar, and LiDAR, along with algorithms to predict and avoid collisions. However, these systems can struggle in complex scenarios where multiple obstacles or rapidly changing conditions are present. Additionally, these systems may not always provide sufficient time or accuracy to effectively mitigate collisions in real-time.

Systems and methods described herein are configured to initiate mitigating actions. Upon detecting an imminent collision, the imminent collision detector module bypasses the vehicle's standard perception, planning, and control system and activates mitigating measures such as adjusting the vehicle's speed, trajectory, or deploying cushioning structures beneath the vehicle.

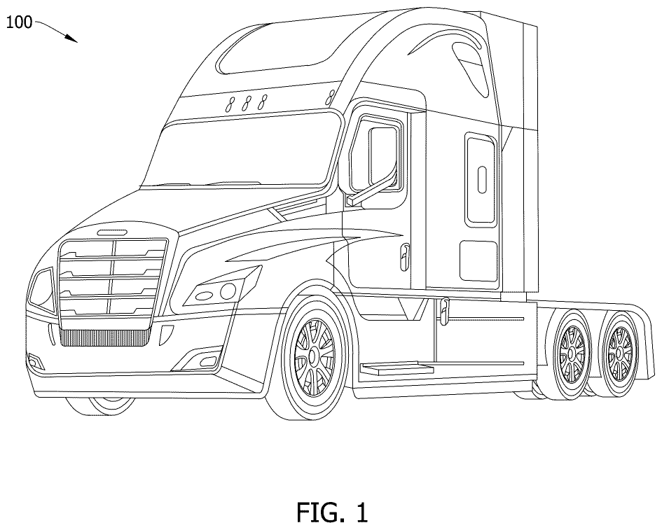

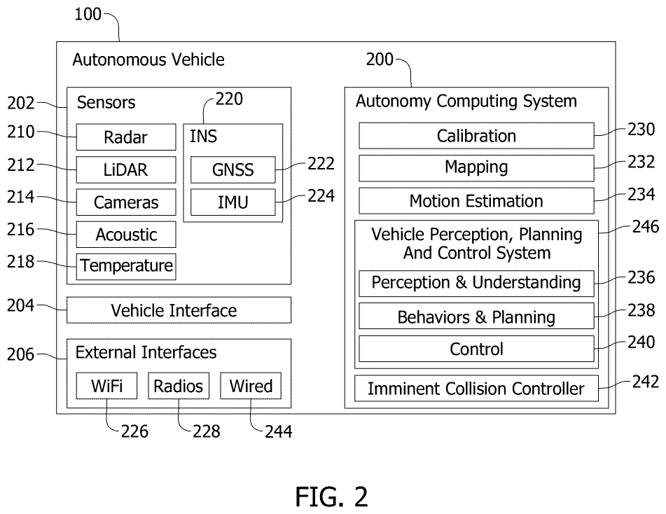

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave.

Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and collision mitigation controller 242. Collision mitigation controller 242, for example, may be embodied within another module, such as behaviors and planning module 238, or separately. As used herein, perception and understanding module 236, behaviors and planning module, and control module 240 are collectively referred to perception, planning, and control system 246, or typical autonomous computing system 200. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Collision mitigation controller 242 determine that a collision is imminent and initiates one or more mitigating actions based on the determination that a collision is imminent. Collision mitigation controller 242 receives, for example data related to one or more objects from a perception and understanding module 236 of the autonomous vehicle 100 and identifies if a collision is imminent. When collision mitigation controller 242 determines that a collision is imminent, collision mitigation controller 242 bypasses a planning and control system to initiate one or more mitigating actions. In some embodiments, typical perception and understanding module 236 may also be bypassed, further increasing the speed of detection of an imminent collision.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

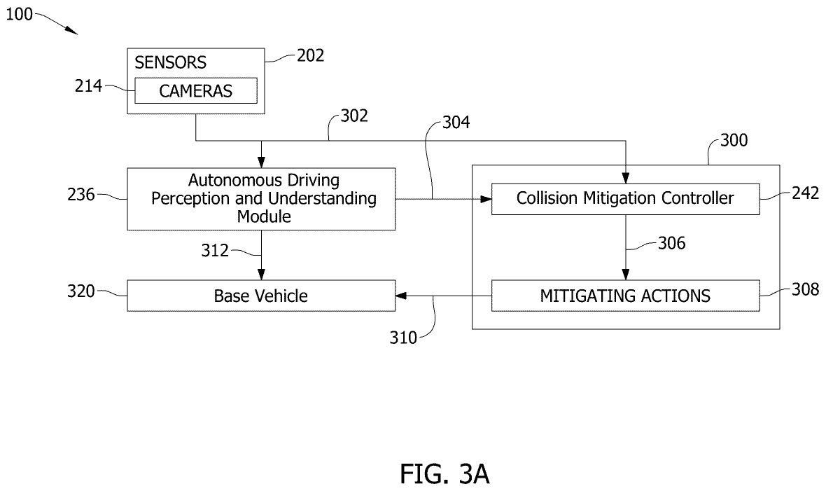

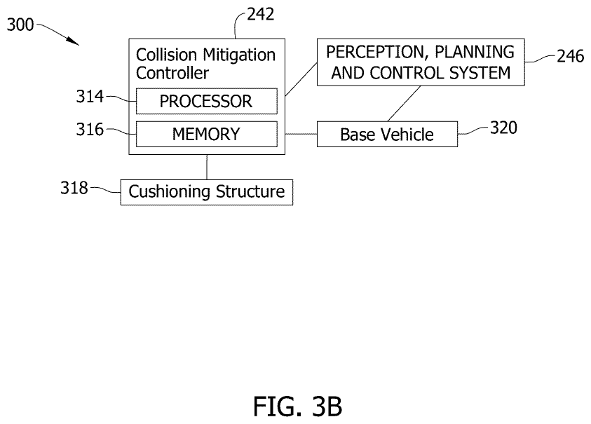

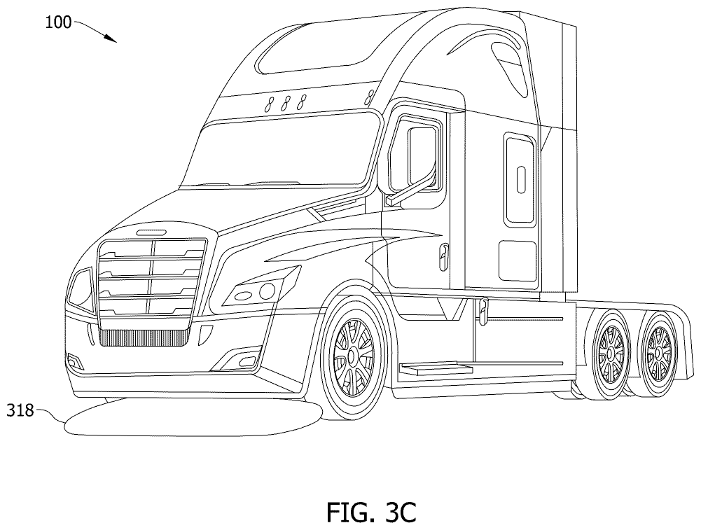

FIG. 3A is a block diagram of an example collision mitigation assembly 300 for an autonomous vehicle 100. Collision mitigation assembly 300 is configured to mitigate damage potential in the event of an imminent collision by triggering mitigating actions 308 when collision mitigation assembly 300 determines that a collision is imminent. Collision mitigation assembly 300 may receive sensor data from a variety of sensors 202, providing environmental information about the surroundings of vehicle 100. In the depicted embodiment, the image data captured by cameras 214 is primarily used. This data is transmitted to one or both perception and understanding module 236 and collision mitigation controller 242.

In the example embodiment, perception and understanding module 236 may process sensor data 302, particularly the image data received from cameras 214. Perception and understanding module 236 analyzes the environment surrounding vehicle 100 and may identify objects such as other vehicles, pedestrians, cyclists, obstacles, and other objects.

Perception and understanding module 236 may also calculate the positions of these objects relative to vehicle 100. Object-related data 304 may include information about the type of object, its location, movement, and velocity. Perception and understanding module 236 sends object-related data 304 to collision mitigation controller 242 for further analysis.

In some embodiments, collision mitigation controller 242 is configured to detect objects based on sensor data 302. For example, collision mitigation controller 242 is configured to detect objects solely based on sensor data 302 from cameras 214. To increase the speed of detection and reduce computation load, only a limited or relatively few number of frames of camera data are used in detection of objects in the environment. For example, the number of frames may be one or two. The number of frames may be predefined or user defined. The number of frames may be adjusted to arrive at an optimum number that balances the quality of detection and speed of computation.

In the example embodiment, upon receiving sensor data 302 and object-related data 304, collision mitigation controller 242 uses processor 314 (see FIG. 3B described later) to analyze the data and determine whether a collision is imminent. Processor 314 evaluates factors such as the proximity, speed, and direction of the detected objects. If a collision is determined to be imminent, collision mitigation controller 242 bypasses the vehicle's typical path planning, perception, and control systems 246 to ensure that immediate and effective action is taken to mitigate the collision. Bypassing the typical perception, planning, and control system 246 means that the vehicle's standard behavior, which relies on ongoing vehicle autonomy and route planning decisions, is bypassed by the collision mitigation assembly, which directly control base vehicle 320 to execute mitigating actions 308. This reduces time to execute mitigating actions 308.

FIG. 3B presents a block diagram of collision mitigation controller 242 for an autonomous vehicle 100. Collision mitigation controller 242 may be integrated into the vehicle's collision mitigation assembly 300 and is responsible for detecting imminent collisions and initiate mitigating actions. Collision mitigation controller 242 includes a processor 314, which is in communication with a memory device 316. Memory device 316 stores instructions for processing data received from perception and understanding module 236 and/or sensor data 302.

In the example embodiment, processor 314 analyzes sensor data 302 and/or object-related data 304 to assess the proximity, speed, and direction of objects in the environment. Based on this analysis, processor 314 determines if a collision is imminent. If the collision is imminent, processor 314 bypasses at least part of the vehicle's perception, planning, and control system 246 and initiates one or more mitigating actions 308 to reduce the potential of risk or damage. These mitigating actions may include adjusting the vehicle's speed, trajectory, or steering, or deploying additional safety mechanisms such as airbags or other safety devices. In some embodiments, mitigating actions 308 may include altering the vehicle's speed or trajectory, deploying a cushioning structure 318 located beneath the vehicle, or activating emergency braking or steering systems.

In some embodiments, collision mitigation controller 242 bypasses the control module 240 and directly controls base vehicle 320 to adjust to the vehicle's motion, including steering, braking, or accelerating. For example, these adjustments are made in response to the mitigation instructions received from the collision mitigation controller 242 to reduce the potential of risk or damage.

In some embodiments, collision mitigation controller includes a detection machine learning model configured to detect an imminent collision based on sensor data. The detection machine learning model may be trained with sensor data captured immediately prior to a collision. “Immediately prior” refers to the relatively brief time period immediately before the occurrence of a collision, generally within a few seconds or fractions of a second before an impact. This time frame provides the most relevant information for predicting imminent collisions. Using data from this short period before a collision improves the system's ability to detect patterns and objects that are involved in an imminent collision scenario. Using a machine learning model trained to detect an imminent collision is advantageous over at least some analytical methods because the real-world driving is unpredictable and difficult to represented with analytical functions, especially for imminent collisions.

In some embodiments, the collision mitigation controller 242 is configured to classify detected objects into classes such as pedestrians, cyclists, vehicles, or other entities. Collision mitigation controller 242 is configured to tailor the response based on the class of object detected. For instance, different mitigating actions may be taken depending on whether the object is a vulnerable road user (VRU), such as a pedestrian or cyclist, versus another vehicle or obstacle. If the object is a VRU, mitigating actions may include steering away from the object to avoid direct impact.

In some embodiments, the threshold for initiating mitigating actions may be adjusted to prioritize execution of mitigation actions 308. In this context, “prioritize” means that collision mitigation controller 242 gives higher priority to initiating mitigating actions as soon as a potential collision is detected, even when the adjusted threshold results in increased false positives (incorrect identification of a collision). Prioritizing mitigation actions may reduce the potential of risk and/or damage from potential collisions, although some actions are triggered by objects that may not actually result in a collision. This strategy is particularly useful in environments where the potential for harm is relatively high and the risk of failure to respond outweighs the cost of false positives.

FIG. 3C is a schematic diagram of an example cushioning structure 318. In some embodiments, the mitigating actions include the deployment of a cushioning structure 318 located beneath the front portion of the vehicle. Cushioning structure 318 is deployed prior to impact to avoid objects, such as small vehicles, pedestrians, or cyclists, from being trapped underneath autonomous vehicle 100. Unlike traditional airbag systems, which are triggered by mechanical mechanisms, cushioning structure 318 is triggered via signals sent directly from collision mitigation controller 242. Triggering via signals from collision mitigation controller 242 is advantageous in facilitating deploying cushioning structure 318 prior to impact, thereby avoiding objects being trapped under autonomous vehicle 100.

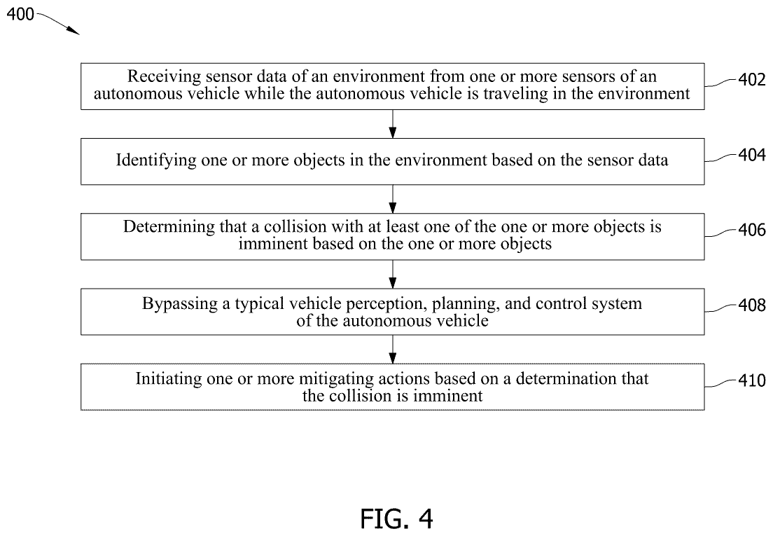

FIG. 4 is a flow chart of an example method 500 of mitigating an imminent collision involving an autonomous vehicle. Method 500 includes receiving 314 sensor data of an environment from one or more sensors of an autonomous vehicle while the autonomous vehicle is traveling in the environment. Method 500 also includes identifying 404 one or more objects in the environment based on the sensor data. Method 500 further includes determining 406 that a collision with at least one of the one or more objects is imminent based on the one or more objects. Moreover, method 500 includes bypassing 408 a perception, planning, and control system of the autonomous vehicle. Further, Method 500 incudes initiating 410 one or more mitigating actions based on a determination that the collision is imminent.

In some embodiments, identifying 404 one or more objects in the environment may be based solely on sensor data captured by one or more cameras. Additionally, identifying 404 one or more objects in the environment may be based solely on a limited number of frames of the sensor data.

In some embodiments, initiating 410 the one or more mitigating actions includes deploying a cushioning structure located beneath a front portion of the autonomous vehicle prior to the collision with the at least one of the one or more objects. Additionally or alternatively, initiating 410 the one or more mitigating actions includes adjusting at least one of speed or trajectory of the autonomous vehicle.

In some embodiments, method 500 further includes classifying the one or more objects. Initiating 410 the one or more mitigating actions may be based on a class of the at least one of the one or more objects.

In some embodiments, method 500 further includes determining, via a detection machine learning model, the collision. The detection machine learning model may be trained on image data captured immediately prior to collisions.

In some embodiments, initiating 410 the one or more mitigating actions further includes adjusting a threshold to initiate the one or more mitigating actions to prioritize the one or more mitigating action.

In some embodiments, initiating 410 the one or more mitigating actions further includes controlling operation of the autonomous vehicle to steer away from the at least one of the one or more objects.

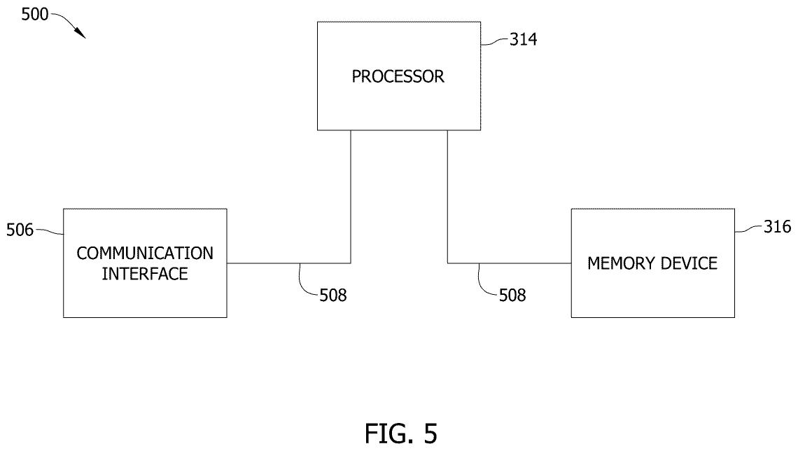

FIG. 5 is a block diagram of an example computing device 500. Autonomy computing system 200 and collision mitigation controller may be implemented with one or more computing devices 500. Computing device 500 includes a processor 314 and a memory device 316. The processor 314 is coupled to the memory device 316 via a system bus 508.

The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 316 includes one or more devices that enable information, such as executable instructions or other data (e.g., sensor data), to be stored and retrieved. Moreover, the memory device 316 includes one or more computer readable media, such as, without limitation, dynamic random access memory (DRAM), static random access memory (SRAM), a solid state disk, or a hard disk. In the example embodiment, the memory device 316 stores, without limitation, application source code, application object code, configuration data, additional input events, application states, assertion statements, validation results, or any other type of data. The computing device 500, in the example embodiment, may also include a communication interface 506 that is coupled to the processor 314 via system bus 508. Moreover, the communication interface 506 is communicatively coupled to data acquisition devices.

In the example embodiment, processor 314 may be programmed by encoding an operation using one or more executable instructions and providing the executable instructions in the memory device 316. In the example embodiment, the processor 314 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

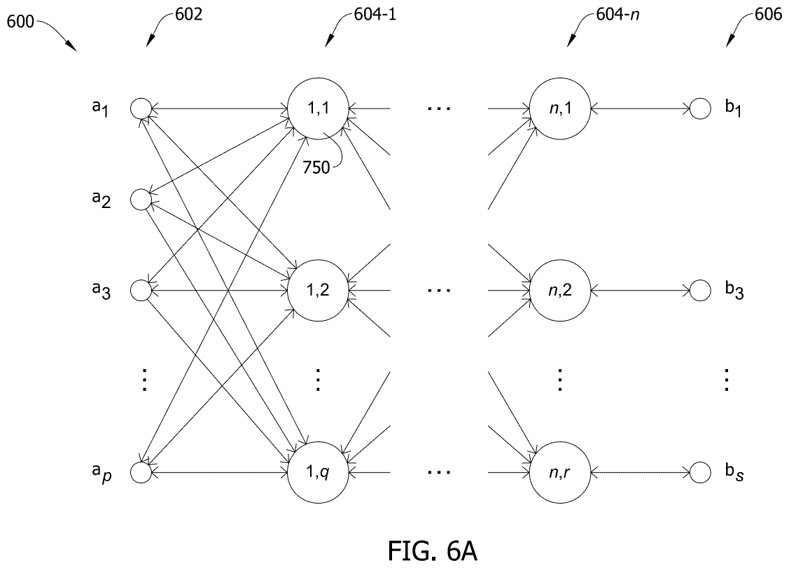

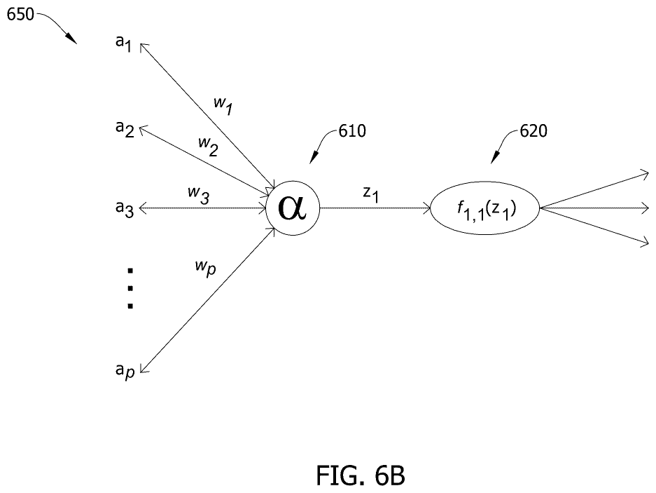

FIG. 6A depicts an example artificial neural network model 600. Collision mitigation assembly 300 may include one or more neural network models 600. The example neural network model 600 includes layers of neurons 650, 604-1 to 604-n, and 606, including an input layer 602, one or more hidden layers 604-1 through 604-n, and an output layer 606. Each layer may include any number of neurons, i.e., q, r, and n in FIG. 6A may be any positive integer. It should be understood that neural networks of a different structure and configuration from that depicted in FIG. 6A may be used to achieve the methods and systems described herein.

In the example embodiment, the input layer 602 may receive different input data. For example, the input layer 602 includes a first input a₁ representing training images, a second input a₂ representing patterns identified in the training images, a third input a₃ representing patterns representing edges of the training images, and so on. The input layer 602 may include thousands or more inputs. In some embodiments, the number of elements used by the neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from the input layer 602, and/or one or more outputs from neurons in one of the previous hidden layers, to generate a decision or output. The output layer 606 includes one or more outputs each indicating a label, confidence factor, weight describing the inputs, and/or an output image. In some embodiments, however, outputs of the neural network model 600 are obtained from a hidden layer 604-1 through 604-n in addition to, or in place of, output(s) from the output layer(s) 606.

In some embodiments, each layer has a discrete, recognizable function with respect to input data. For example, if n is equal to 3, a first layer analyzes the first dimension of the inputs, a second layer analyzes the second dimension, and the final layer analyzes the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 6A, according to one embodiment. Each of the inputs to the neuron 650 (e.g., the inputs in the input layer 602 in FIG. 6A) is weighted such that input a₁ through aₚ corresponds to weights w₁ through wₚ as determined during the training process of the neural network model 600.

In some embodiments, some inputs lack an explicit weight, or have a weight below a threshold. The weights are applied to a function a (labeled by a reference numeral 610), which may be a summation and may produce a value z₁ which is input to a function 620, labeled as f_{1,1}(z₁). The function 620 is any suitable linear or non-linear function. As depicted in FIG. 6B, the function 620 produces multiple outputs, which may be provided to neuron(s) of a subsequent layer, or used as an output of the neural network model 600. For example, the outputs may correspond to index values of a list of labels, or may be calculated values used as inputs to subsequent functions.

It should be appreciated that the structure and function of the neural network model 600 and the neuron 650 depicted are for illustration purposes only, and that other suitable configurations exist. For example, the output of any given neuron may depend not only on values determined by past neurons, but also on future neurons.

The neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, the neural network model 600 may learn how to identify characteristics and patterns that may then be applied to analyzing image data, model data, and/or other data. For example, the model 600 may learn to identify features in a series of data points.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) resource-efficient imminent collision detection or (b) rapid activation of mitigating actions by bypassing at least part of perception, planning, and control system.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A collision mitigation assembly of an autonomous vehicle for mitigating an imminent collision involving the autonomous vehicle, the collision mitigation assembly comprising:
a collision mitigation controller separate from an autonomous driving perception and understanding module of the autonomous vehicle, comprising at least one processor in communication with at least one memory device, the at least one processor programmed to:
receive sensor data of an environment directly from one or more sensors of the autonomous vehicle while the autonomous vehicle is traveling in the environment;
identify one or more objects in the environment based solely on the sensor data captured by one or more cameras and using only a predetermined number of frames of sensor data, the predetermined number of frames being less than an original number of frames in the sensor data;
determine that a collision with at least one of the one or more objects is imminent based on the identification of the one or more objects;
bypass at least part of a perception, planning, and control system of the autonomous vehicle;
initiate one or more mitigating actions based on the determination that the collision is imminent; and
control operation of the autonomous vehicle based on the one or more mitigating actions.

2. (canceled)

3. (canceled)

4. The collision mitigation assembly of claim 1, further comprising a cushioning structure located beneath a front portion of the autonomous vehicle, wherein the at least one processor is further programmed to:
initiate the one or more mitigating actions by deploying the cushioning structure prior to the collision with the at least one of the one or more objects.

5. The collision mitigation assembly of claim 1, wherein the at least one processor is further programmed to:
initiate the one or more mitigating actions by adjusting at least one of speed or trajectory of the autonomous vehicle.

6. The collision mitigation assembly of claim 1, wherein the at least one processor is further programmed to:
classify the one or more objects; and
initiate the one or more mitigating actions based on a class of the at least one of the one or more objects.

7. The collision mitigation assembly of claim 1, wherein the at least one processor is further programmed to:
determine, via a detection machine learning model, the collision, wherein the detection machine learning model is trained on image data captured immediately prior to collisions.

8. The collision mitigation assembly of claim 1, wherein the at least one processor is further programmed to:
adjust a threshold to initiate the one or more mitigating action.

9. The collision mitigation assembly of claim 1, wherein the at least one processor is further programmed to:
initiate the one or more mitigating actions by controlling operation of the autonomous vehicle to steer away from the at least one of the one or more objects.

10. A method for mitigating an imminent collision involving an autonomous vehicle, the autonomous vehicle including a collision mitigation controller separate from an autonomous driving perception and understanding module of the autonomous vehicle, the method comprising:
receiving sensor data of an environment directly from one or more sensors of the autonomous vehicle while the autonomous vehicle is traveling in the environment;
identifying one or more objects in the environment based solely on the sensor data captured by one or more cameras and using only a predetermined number of frames of sensor data, the predetermined number of frames being less than an original number of frames in the sensor data;
determining that a collision with at least one of the one or more objects is imminent based on the identification of the one or more objects;
bypassing at least part of a perception, planning, and control system of the autonomous vehicle;
initiating one or more mitigating actions based on the determination that the collision is imminent; and
controlling operation of the autonomous vehicle based on the one or more mitigating actions.

11. (canceled)

12. (canceled)

13. The method of claim 10, wherein initiating the one or more mitigating actions comprises deploying a cushioning structure located beneath a front portion of the autonomous vehicle prior to the collision with the at least one of the one or more objects.

14. The method of claim 10, wherein initiating the one or more mitigating actions comprises adjusting at least one of speed or trajectory of the autonomous vehicle.

15. The method of claim 10, further comprising classifying the one or more objects, wherein initiating the one or more mitigating actions based on a class of the at least one of the one or more objects.

16. The method of claim 10, further comprising determining, via a detection machine learning model, the collision, wherein the detection machine learning model is trained on image data captured immediately prior to collisions.

17. The method of claim 10, further comprising adjusting a threshold to initiate the one or more mitigating action.

18. The method of claim 10, wherein initiating the one or more mitigating actions further comprises controlling operation of the autonomous vehicle to steer away from the at least one of the one or more objects.

19. A non-transitory computer-readable medium storing instructions that, when executed by a processor of a collision mitigation controller separate from an autonomous driving perception and understanding module of an autonomous vehicle, cause the processor to perform a method for mitigating an imminent collision involving the autonomous vehicle, the method comprising:
receiving sensor data of an environment directly from one or more sensors of the autonomous vehicle while the autonomous vehicle is traveling in the environment;
identifying one or more objects in the environment based solely on the sensor data captured by one or more cameras and using only a predetermined number of frames of sensor data, the predetermined number of frames being less than an original number of frames in the sensor data;
determining that a collision with at least one of the one or more objects is imminent based on the identification of the one or more objects;
bypassing at least part of a perception, planning, and control system of the autonomous vehicle;
initiating one or more mitigating actions based on the determination that the collision is imminent; and
controlling operation of the autonomous vehicle based on the one or more mitigating actions.

20. (canceled)
